(19) United States
(12) Patent Application Publication
(10) Pub. No.: US 2019/0016544 A1
(43) Pub. Date: Jan. 17, 2019

(54) ROTATIVE STACKING DEVICE

(71) Applicant: CARBOTECH INTERNATIONAL, Plessisville (CA)

(72) Inventors: Andre NADEAU, Blainville (CA); Claude LAPRISE, Sainte-Marguerite (CA); Jonatan LABRIE, Saint-Henri-de-Levis (CA)

(21) Appl. No.: 16/023,527

(22) Filed: Jun. 29, 2018

Related U.S. Application Data
(60) Provisional application No. 62/532,625, filed on Jul. 14, 2017.

(51) Int. Cl. B65G 57/10; B65G 57/18

(52) U.S. Cl. CPC B65G 57/10; B65G 2201/0282; B65G 57/18

(57) ABSTRACT

A stacking machine for stacking elongated members in a stack comprises a frame and a pair of cooperating stackers mounted thereto distant from each other. Each of the stackers comprises a driven master wheel, a slave wheel mounted eccentrically from the master wheel, a stacking arm assembly concurrently mounted to the master wheel and the slave wheel causing the master wheel to drive the slave wheel and a stacking arm assembly mounted to the stacking arm assembly, the stacking arm assembly comprising a stacking blade extending substantially parallel to the master wheel and defining a stacking face. The stacking faces of the cooperative stackers define a stacking plane supporting a layer of elongated members to be stacked, whereby the layers are moved one at a time on a stack.

### CROSS-REFERENCE TO RELATED APPLICATION

This application is a continuation-in-part of U.S. patent application 62/532,625 filed Jul. 14, 2017, the specification of which is incorporated by reference.

### BACKGROUND

### (a) Field

The present device and process relate generally to methods and machines for stacking material, and more particularly, to methods and machines for stacking elongated planar members, such as sheets of lumber, plywood, or other material, into packages to facilitate subsequent shipping and/or handling.

### (b) Related Prior Art

The lumber industry, in particular, uses stacking machines (or stackers) to collect sheets (or pieces) of lumber, plywood, and other wood products into packages (or bundles) to facilitate bulk handling and shipping. Lumber is generally produced in lengths between 4′ to 28′, with thicknesses ranging from 1″ to 12″, and having widths that range between 2″ to 24″. After production, the lumber is generally gathered into layers (or courses) and then supplied to a stacker where it is formulated into packages that are typically approximately 16 to 30+ layers high and range from about 42″ to 96″ in width.

The stacking process requires robust machinery. It is also desirable to have a stacker that is capable of efficiently stacking the lumber at a very high speed. It is further desirable to have stacking machinery that is easy to maintain and that requires very little supervision or manual tuning during the stacking process. The longer the machines are kept up and running between down times and the less manual intervention that is required, the better the process efficiency. Greater efficiency results in increased production and enhanced profitability.

The industry is therefore in need of faster and more reliable methods and systems for stacking the materials that are to be bundled together. In particular, in sawmills and planer mills that manufacture lumber and other wood products, the speed of equipment that feeds conventional stackers has increased, without a corresponding increase in the stacking speed. This results in bottlenecks and inefficiencies at the stackers.

Conventional stackers are generally unable to meet the high demands placed on them by current lumber feed systems. Typically, a package of lumber is formed in the stacker using a set of forks (or stacker arms) to raise a course of lumber from stacker chains. The arms are then extended to an area containing the accumulated courses. Once the course of lumber has been set on top of the stack, the stacker arms retreat to pick up the next course. This process is repeated until the desired number of courses have been set and a full package has been created. The package can then be bundled and shipped, or subjected to further processing.

U.S. Pat. Nos. 4,290,723 and 5,613,827, U.S. patent application No. 2003/0031550, and Canadian patents CA 2354979, CA 2463210 and CA 2559649, disclose various machinery and methods for stacking courses of lumber into packages. Unfortunately, none of these, or other known conventional stacker designs, are able to stack lumber at the high stacking rates required to keep up with the increased speed of present feed systems. Conventional systems, for example, are only capable of a maximum of about 15 cycles per minute for a single carriage stacker, and around 24 cycles per minute for a dual carriage stacker-not taking into account down time between loads being stacked and general inefficiencies of the infeed and outfeed systems of the stacker.

There is therefore a need for a new design of stacking machines responding to the shortcomings of the existing stacking machines.

### SUMMARY

According to an embodiment, there is provided a stacking machine for stacking elongated members. The stacking machine comprises: a stacker comprising: a master wheel; a slave wheel mounted eccentrically relative to the master wheel; a link arm assembly linking the master wheel and the slave wheel; and a stacking arm assembly mounted to the link arm assembly; wherein, under rotation of the master wheel, the slave wheel is driven to rotate hence driving the stacking arm assembly to rotate to receive layers of elongated members and to move them to form a stack using the layers of elongated members.

According to an aspect, the link arm assembly comprises a linking arm pivotably mounted to the master wheel and to the slave wheel, thereby joining the master wheel and the slave wheel.

According to an aspect, the stacking arm assembly comprises a stacking arm rigidly mounted to the link arm assembly, wherein orientation of the linking arm determines orientation of the stacking arm.

According to an aspect, the orientation of the stacking arm remains constant over a rotation of the master wheel.

According to an aspect, the stacking arm assembly comprises: an extend segment extending from the stacking arm; and a stacking blade mounted substantially perpendicular to the extend segment, wherein the stacking blade receives the layers of elongated members.

According to an aspect, the stacking arm assembly comprises a slidable sleeve mounted to the stacking arm and to which is mounted the extend segment.

According to an aspect, the stacking machine comprises at least two link arm assemblies and a corresponding number of stacking arm assemblies.

According to an aspect, the stacking machine further comprises a driving shaft driving the master wheel, and a drum on which is mounted to the slave wheel, wherein the shaft passes through the drum.

According to an aspect, the stacking machine further comprises another stacker, wherein the corresponding ones of the stacking arm assemblies of the stacker and the other stacker define a stacking plane to receive a layer of elongated members.

According to an aspect, the stacker and the other stacker are mounted at a distance from each other providing clearance therebetween for a conveyor to feed the stacking machine with layers of elongated members.

According to an aspect, the stacking machine further comprises a frame, a motor and a main driving shaft mounted to the frame and driven by the motor, wherein the motor drives the stacker and the other stacker through the main driving shaft.

According to an aspect, the stacking machine further comprises a frame and skates, wherein one of the stacker and the other stacker is mounted to the skates themselves mounted to the frame, and wherein one of the stacker and the other stacker is slidable toward and away from the cooperating stacker.

According to an aspect, the stacking machine further comprises a stacking table comprising supports supporting the stack of elongated members at a height relative to the frame, wherein the supports are motorized to adjust the height of the top of the stack.

According to an aspect, the stacking machine further comprises a controller and a height detector, wherein the controller commands the motorized supports based on the height detected by the height detector.

According to an aspect, the master wheel comprises a rotation axis, a plurality of link arm assemblies and axes about which the link arms assemblies are mounted to the master wheel, wherein the axes are at an equal distance from the rotation axis, and wherein the axes are equidistant from each other.

According to an embodiment, there is provided a stacking machine for stacking elongated members in a stack. The stacking machine comprises: a pair of cooperating stackers mounted distant from each other, each of the stackers comprising: a master wheel; a slave wheel mounted eccentrically relative to the master wheel; a link arm assembly linking the master wheel and the slave wheel; and a stacking arm assembly mounted to the link arm assembly; wherein, under rotation of the master wheels, the slave wheels are driven to rotate hence driving a pair of corresponding stacking arm assemblies from the stackers to rotate to receive layers of elongated members and to move them to form a stack using the layers of elongated members.

According to an aspect, the stacking arm assemblies are mounted as a pair comprising a first stacking arm assembly from a first one of the pair of stackers and a second stacking arm assembly from a second one of the pair of stackers, wherein the pair of stacking arm assemblies define a stacking plane to receive a layer of elongated members.

According to an aspect, the stacker and the other stacker are mounted at a distance from each other providing clearance therebetween for a conveyor to feed the stacking machine with layers of elongated members.

According to an aspect, the stacking machine further comprises a frame, a motor and a main driving shaft mounted to the frame and driven by the motor, wherein the motor drives the pair of stackers through the main driving shaft.

According to an embodiment, there is provided a stacker for a stacking machine adapted for stacking elongated members in a stack. the stacker comprising: a base; a master wheel mounted to the base; a slave wheel mounted to the base eccentrically to the master wheel; a stacking arm assembly concurrently mounted to the master wheel and the slave wheel causing the master wheel to drive the slave wheel; and a stacking arm assembly mounted to the stacking arm assembly; wherein, under rotation of the master wheels, the slave wheels are driven to rotate hence driving a pair of corresponding stacking arm assemblies from the stackers to rotate to receive layers of elongated members and to move them to form a stack using the layers of elongated members.

### BRIEF DESCRIPTION OF THE DRAWINGS

Further features and advantages of the present disclosure will become apparent from the following detailed description, taken in combination with the appended drawings, in which:

FIG. 1 is a perspective view of a stacking machine in accordance with an embodiment;

FIG. 2 is a perspective view of a portion of the stacking machine of FIG. 1;

FIG. 3 is a close-up perspective view of a portion of the stacking machine of FIGS. 1 and 2;

FIG. 4 is a close-up perspective view of another portion of the stacking machine of FIGS. 1 to 3;

FIG. 5 is a perspective view of specific components of one stacker of the stacking machine of FIGS. 1 to 4;

FIG. 6 is a cutout view of specific components of one stacker of the stacking machine of FIGS. 1 to 5;

FIG. 7 is a cutout view of the stacking machine showing the left stacker from the center illustrating the feeding of layers of pieces of lumber to the stacking machine according to an embodiment; and

FIGS. 8A to 8C are close-up views of the left stacker piling up an additional layer over the stack at different moments of the stacking process.

It will be noted that throughout the appended drawings, like features are identified by like reference numerals.

### DETAILED DESCRIPTION

It is to be noted that the embodiments, geometrical configurations, materials mentioned and/or dimensions shown in the figures or described in the present description are embodiments only, given for exemplification purposes. Moreover, the terms left and right are used for explanation purpose only and refer to a point of view from the upstream process, from the board feeding component. The terms top and bottom refer to usual installation with normal implication of gravitational force over the components.

Throughout the present document, expressions such as “conveying”, “transferring”, “displacing”, “wood board”, “lumber”, “mill”, etc., used herein should not be taken as to limit the scope of the present disclosure and include all other kinds of objects or fields with which the present disclosure could be used and may be useful.

Moreover, in the context of the present disclosure, the expressions “system”, “assembly”, “unit”, “device” and any other equivalent expression and/or compound words thereof known in the art will be used interchangeably. Furthermore, the same applies for any other mutually equivalent expressions, such as “wood board”, “board”, “lumber”, “elongated piece of lumber”, “log”, “plank” and the like, “stacking”, “piling”, “making a heap”, “placing a layer” and the like, as well as “segment”, “portion” and “section”, for example, as also apparent to a person skilled in the art.

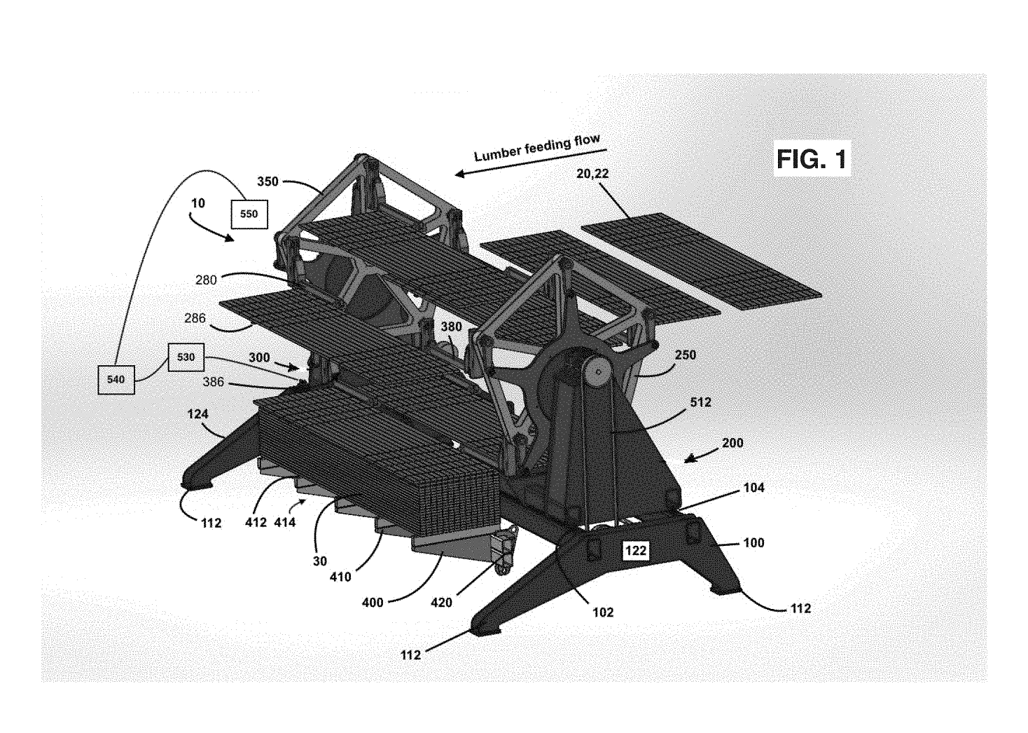

Referring now to the drawings, and more particularly to FIG. 1, there is shown a stacking machine 10 for stacking pieces of lumber 22 (aka elongated members) arranged in a layer 20 to be placed on top of a stack 30. According to an embodiment, the stacking machine 10 comprises a frame 100 on which is mounted a left stacker 200 and a right stacker 300 cooperating with each other for stacking. The left stacker 200 and right stacker 300 are mounted on rails 102,104 over the frame 100 for controlling the distance between the left stacker 200 and the right stacker 300, therefore adjusting for the length of the pieces of lumber 22 to stack as will be explained in more details. The stacking machine 10 further comprises a stacking table 400. The stacking table 400 is an elevation table adjusting its height as the stack 30 increase in height to have a constant height for a new layer to place on top of the stack 30.

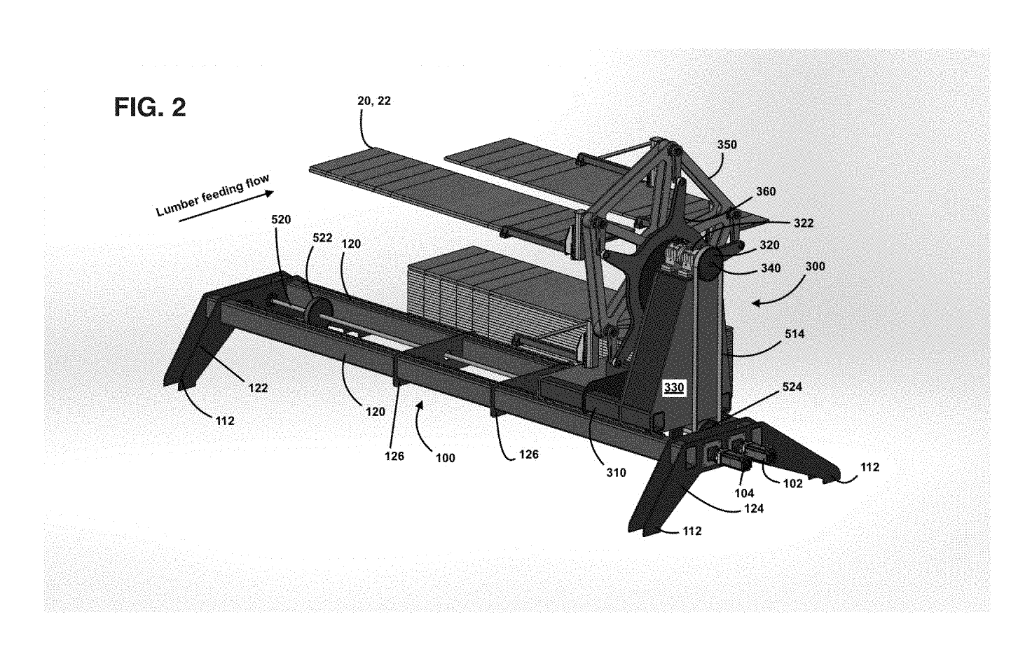

Still referring to FIG. 1 and additional to FIG. 2, the frame 100 comprises four feet 112 which are in pairs on a left leg 122 and on a right leg 124 each disposed parallel to the lumber feeding flow and perpendicular to the orientation of the pieces of lumber 22. The left leg 122 and the right leg 124 are joined to each other by the beams 120 and flanges 126 joining the beams at some positions between the left leg 122 and the right leg 124. The rails 102, 104 are disposed parallel to the beams 120, supported over their lengths by the left leg 122 and at least one of the flanges 126. Based on the rails being used to move one or both of the left stacker 200 and the right stacker 300, the rails 102, 104 may extend over a short length or over the entire distance between the left leg 122 and the right leg 124. The frame 100 defines a rigid structure on which are mounted the left stacker 200, the right stacker 300 and according to the present embodiment the stacking table 400.

Still referring to FIG. 1, the stacking table comprises a series of supports 410 mounted to a motorized table head 420 and having a support face 412 extending horizontally away from the table head 420. The support faces 412 of the supports 410 define a stacking table 414 for supporting a stack 30. The motorized table head 420 is connected to a motor 530 (schematically shown as a block), under control of a controller 540 (schematically shown as a block) and itself connected to stack height detectors 550 (schematically shown as a block), for the motor 530 to move the stacking table 414 up and down based on the presence and height of a stack on the stacking table 414. The supports 410 are disposed parallel to the lumber feeding flow to provide clearance therebetween for a fork lift and to have the forking blades lifting out a stack 30 from the stacking table 400 when complete. Alternative stack handling solutions are also available, each taking advantage of the clearance between the supports 410.

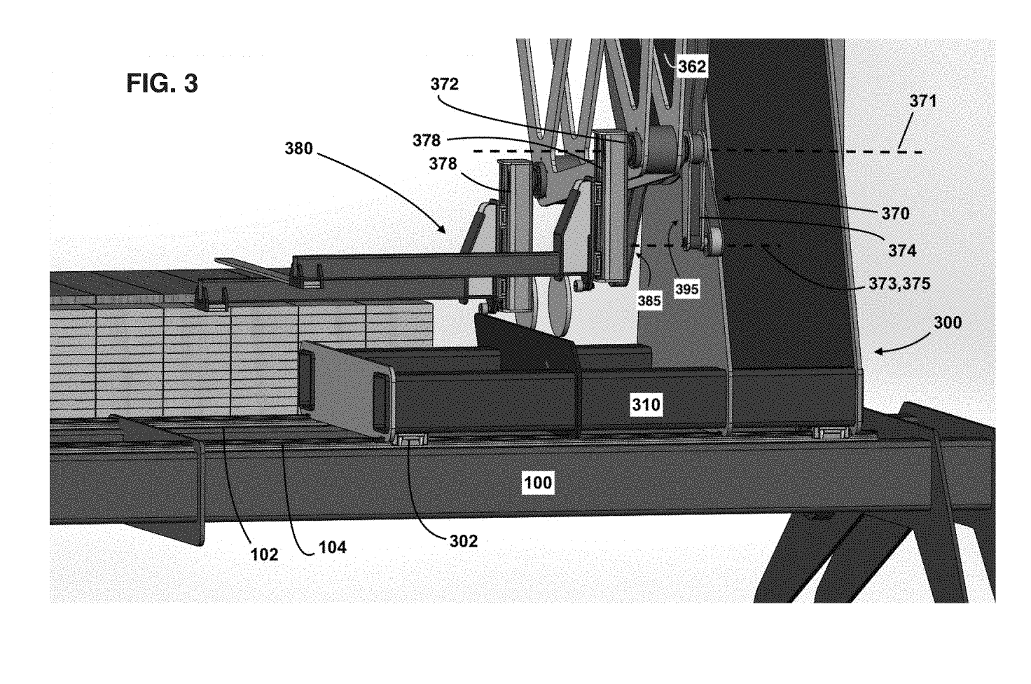

Referring now to FIGS. 2 and 3, the right stacker 300 is mounted to the frame 100 over the rails 102, 104. The right stacker 300 comprises a base 310 mounted to the rails 102, 104 over skates 302. The function of the skates 302 is to allow easy displacement of the right stacker 300 over the rails 102, 104. Thus, the nature of the skates 302 may vary, including low-friction pads and cylindrical bearings for example. According to an embodiment, displacement of the right stacker 300 over the rails 102, 104 may be performed manually, or it may be motorized (motor not shown).

Referring to FIG. 2, the right stacker 300 is shown driven by a right driving belt 514. The right driving belt 514 is connected on top to a driving wheel 320 and at the bottom to a right driving wheel 524. The right driving wheel 524 is mounted to the driving shaft 520 on which is also mounted, substantially at the other end of the frame 100, a left driving wheel 522 to drive the left stacker 200 with a left driving belt 512 (see FIG. 1). Accordingly, both the left stacker 200 and the right stacker 300 are driven in synchronicity by a single motor 530 connected to the driving shaft 520.

It is to be noted that the left stacker 200 and right stacker 300 are shown driven through driving belts 512, 514. One must understand that alternative driving means may also be used and are intended to be part of the scope of the present description. Examples of alternative driving means include driving belts, parallel electric motors, orbital motors fed with hydraulic power, to list a few.

Still referring to FIG. 2, the right stacker 300 comprises a body 330 mounted to the base 310. Mounted to the body 330 distant from the base 310, a driving shaft 340 is connected at one extremity to the driving wheel 320 and at the other end to the master wheel 350. The driving shaft 340 is mounted to the body 330 on one or more shaft supports 322. In the illustrated embodiment, two shaft supports 322 are illustrated mounted side by side to the head of the support. These shaft supports 322 are rotational heavy-load bearings providing alignment and rotation freedom to the driving shaft 340 while supporting the weight of an important portion of the right stacker 300 and half of the weight of a layer 20 of pieces of lumber 22.

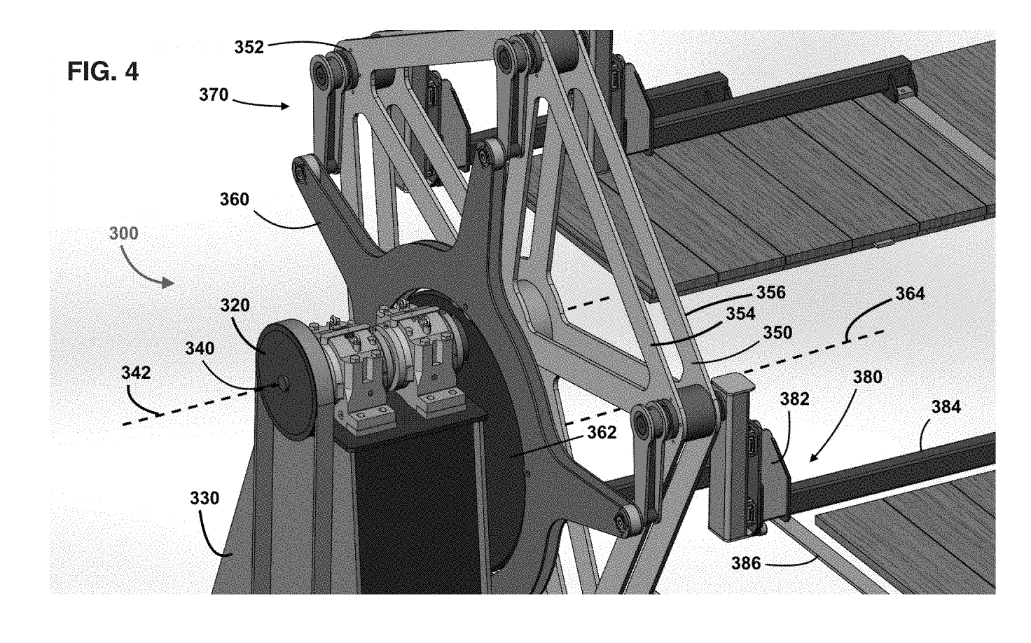

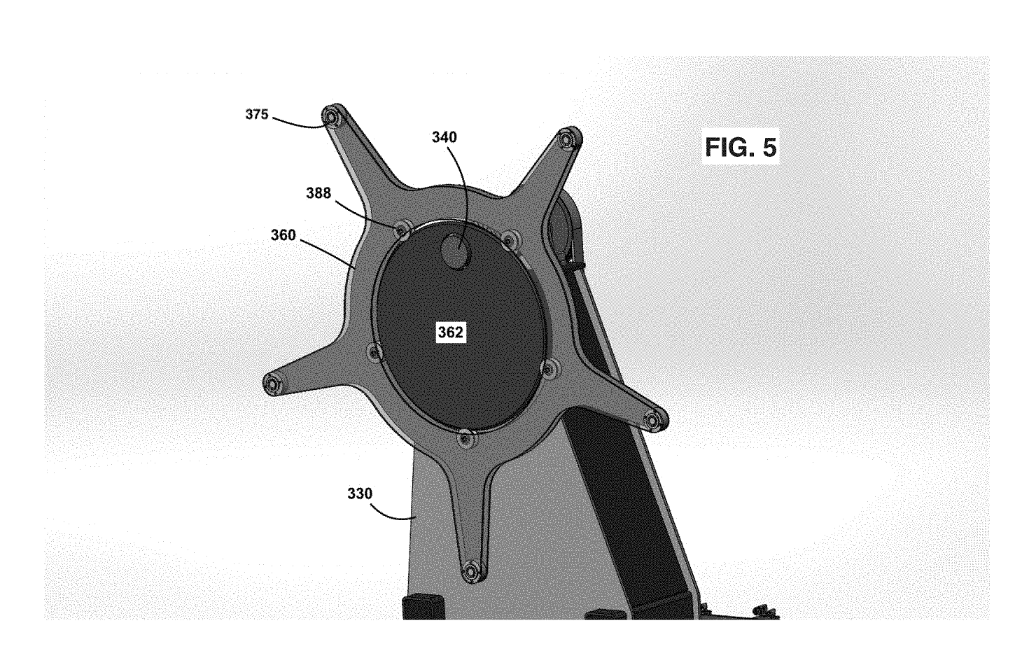

Now referring additionally to FIGS. 4 to 6, the driving shaft 340 passes through a drum 362 on which is mounted the slave wheel 360. The driving shaft 340 drives the master wheel 350. The master wheel 350 features a series of bores 352 at equidistance from its rotation axis 342 (aka the master rotation axis). Each of the bores 352 provides a passage through which a link arm 370 connected at one extremity to the slave wheel 360 and at the other extremity to the stacking arm 380 travels. The bores 352 provides a rotation free passage allowing a rotation of the link arms 370 relative to the master wheel 350.

Link arm assembly 395 comprises a link arm 370 and the connections of the link arm 370 to the master wheel 350 and the slave wheel 360. The link arm assemblies 395 join the master wheel 350 with the slave wheel 360. The master wheel 350, when rotating, thus drives the slave wheel 360 through the link arm assembly 395.

The slave wheel 360 is mounted to the drum 362, itself mounted to the body 330 of the right stacker 300. The drum 362 comprises a passage for the driving shaft 340 to connect the driving shaft 340 at one extremity to the driving wheel 320 and at the other extremity to the master wheel 350. The drum 362 remains still relative to the body 330. The drum 362 features a circular perimeter, with the slave wheel 360 mounted to drum 362. The slave wheel 360 is mounted on bearings or similar means providing capability to the slave wheel 360 to rotate freely about the drum 362 around its rotation axis 364 (aka the slave rotation axis). In the illustrated embodiment, sets of cylindrical bearings 388 are mounted to the slave wheel 360 at a plurality of locations around the drum 362, enabling the slave wheel 360 to rotate easily on the drum 362 by rolling on the sets of cylindrical bearings 388.

It further must be noted that the shape of the master wheel 350 as a pentagonal shape having bridges linking the contour frame of the pentagonal shape to the central part of the of master wheel 350 is a specific embodiment of the master wheel 350 and does not limit the scope of the shapes the master wheel 350 may take. For instance, the master wheel 350 may be shaped as a full circular wheel, a circular shape having a series of openings distributed evenly on its surface, or another available shape able to provide the necessary strength at the bores 352 to support the forces applied by the link arms 370 and its own weight. Preferably, the shape of the master wheel 350 is selected to be have a center of mass at its rotation axis 342, therefore limiting the power necessary for the motor to spin the master wheel 350 and to limit unbalancing of the wheel to the weight of the layers of lumber 22 when in operation. The shape is further selected based on the number of desired stacking arms 380 and the dimension of the stacking arms 380, and more precisely the length of the stacking blades 386 to prevent interference between neighboring stacking arms 380.

The master wheel may also consist in twin wheels 354, 356 joined at the center and the bores 352 with joining components offering the necessary passage to the driving shaft 340 and the bores 352, and additionally or alternatively with other joining components fastening the twin wheels 354, 356 together at other locations. Such joining components may be fastened to the twin wheels with bolts, with rivets, being welded, or through other known fastening methods.

It also must be noted that the shape of the slave wheel 360 as a star-type shape is a specific embodiment of the slave wheel 360 and does not limit the scope of the shapes the slave wheel 360 may take. For instance, the slave wheel 360 may take similar any of the shapes described above in relation with the master wheel 350. Design requirements, such as size, number of link arms 370, strength and material are deterministic over the shape of the slave wheel 360. Furthermore, the slave wheel 360 may comprise a single component as illustrated or may comprise multiple components fastened together as the slave wheel 360.

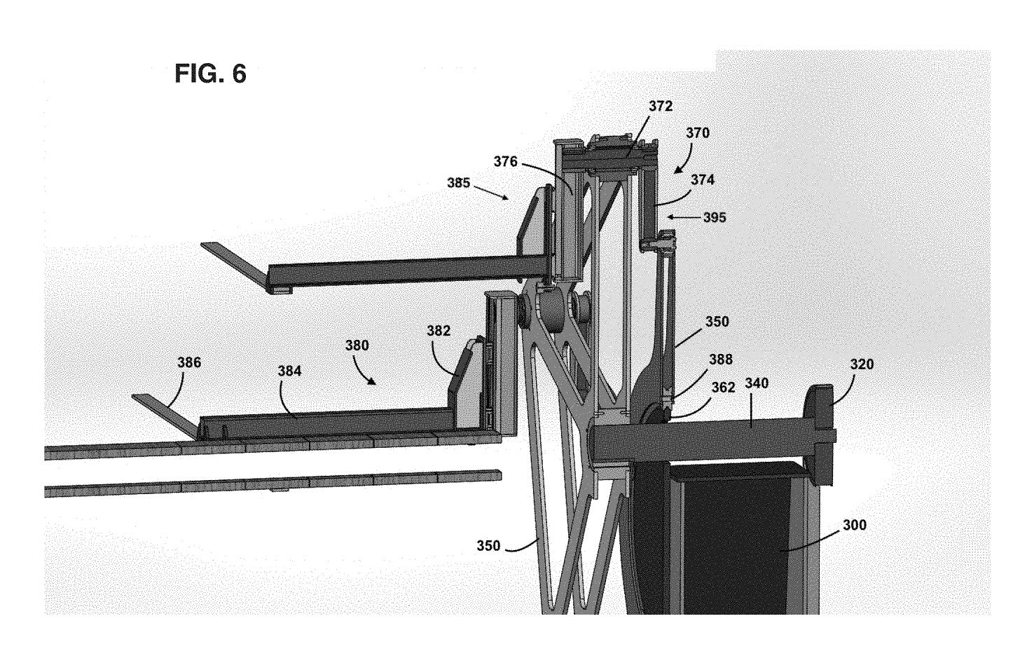

Now referring to FIGS. 3 and 6, each one of the link arms 370 comprises a master shaft 372 that comprises a linear cylindrical component for rotating freely in a corresponding bore 352 of the master wheel 350 about the bore axis 371. Each of the link arms 370 comprises a master-slave arm 374 linking rigidly the master shaft 372 to the slave shaft 375 about the slave arm axis 373. At the other end of the master shaft 372, a stacking arm assembly 385 is rigidly mounted thereto, the stacking arm assembly 385 comprising a master-stacking arm 378. The master-slave arm 374 and the master-stacking arm 378, since rigidly connected to the master shaft 372, define a static shape, in the present embodiment, a U shape. Thus, the orientation of the master-slave arm 374, one tail of the U shape, determining the orientation of the master-stacking arm 378, the other tail of the U shape, and accordingly other components of the stacking arm assembly 385.

One must note that the number of link arm assemblies 395 and stacking arm assemblies 385 are the same, having one stacking arm assembly 385 mounted to a corresponding link arm assembly 395. According to embodiments, both link arm assemblies 395 and stacking arm assemblies 385 are plural, allowing concurrent functions to be performed by the stacking machine 10 at the same as will be discussed below.

One must note that the distance between the rotation axis 342, 364 of the wheels and the rotation axes 371, 373 of the attachment to the link arms is the same for both wheels 350, 360. Similarly, the radius according to which the link arm rotation axes (the bore axis 371 and the slave arm axis 373) are located are of the same dimension. Accordingly, the distance between corresponding link rotation axes 371 and 373 remain the same regardless of the angle of rotation of the wheels 350, 360, determined by the distance between the rotation axis 342 of the master wheel 350 and the rotation axis 364 of the slave wheel 360.

Now referring to FIG. 4, additional components of the stacking arm assembly 385 are described. Each of the stacking arms 380, through a slidable sleeve 382, are mounted to a link arm 370 capable of sliding along the link arm 370. The stack arms 380 may therefore move up and down, sliding along the master-stacking arm 378, to adapt to the needs, particularly at the step of putting down a layer 20 on top of a stack 30 on the stacking table 400 wherein the stacking blade 386 must move substantially horizontally while laying down the layer 20 over the stack 30. Perpendicular to the link arms 370, extending inwardly, is the extend segment 384. At the extremity of the extend segment is secure, extending in the direction of the flow of the pieces of lumber 22 are the stacking blades 386 for receiving a layer 20 of pieces of lumber 22. The stacking blades 386 feature a flat top surface that operates as a stacking face 392 to receive a layer 20 of pieces of lumber 22. In combination with a stacking face 392 from the cooperative stacker 200, 300, the stacking faces 392 defines a stacking plane common to the base of the layer 20 of elongated members 22 to be stacked. The stackers 200, 300 and more precisely as illustrated on FIG. 1 a stacking arm 280 of the left stacker 200 and a stacking arm 380 of the right stacker 300 at corresponding positions on the left stacker 200 and right stacker 300 operate as a pair. The stacking face 392 of the stacking blades 286, 386 form the extremities of a stacking surface on which can be placed a layer 20 to be moved to the top of the stack 30.

It must be noted that the stacking plane involves the stackers 200, 300 to work in a synchronous fashion. The wheels of the stackers 200, 300 rotate at the same time, at the same speed, and are always at the same angle. Thus, the corresponding stacking blades 286, 386 are always at the same height, defining a horizontal stacking plane relative to the rotation axis 342, 364.

According to an embodiment, the stacking blades 386 are movable sliding along the extend segment 384. Accordingly, based on requirements, the stacking blades 386 may be sled to provide more or less clearance and support to the layer 20 to be moved, for instance to respond to less rigid material.

According to an embodiment (not shown), the extend segment 384 are telescopic components which are able to extend over different distance toward the opposed stacker 200, 300. Accordingly, extend segment 384 and stacking blades 386 may provide more or less clearance between the stackers 200, 300.

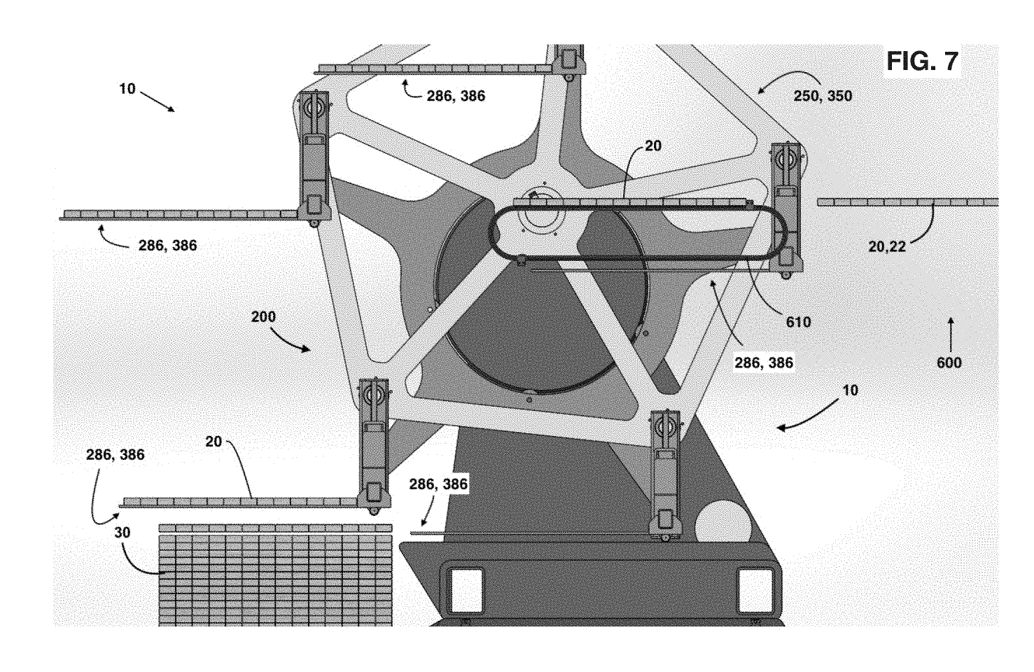

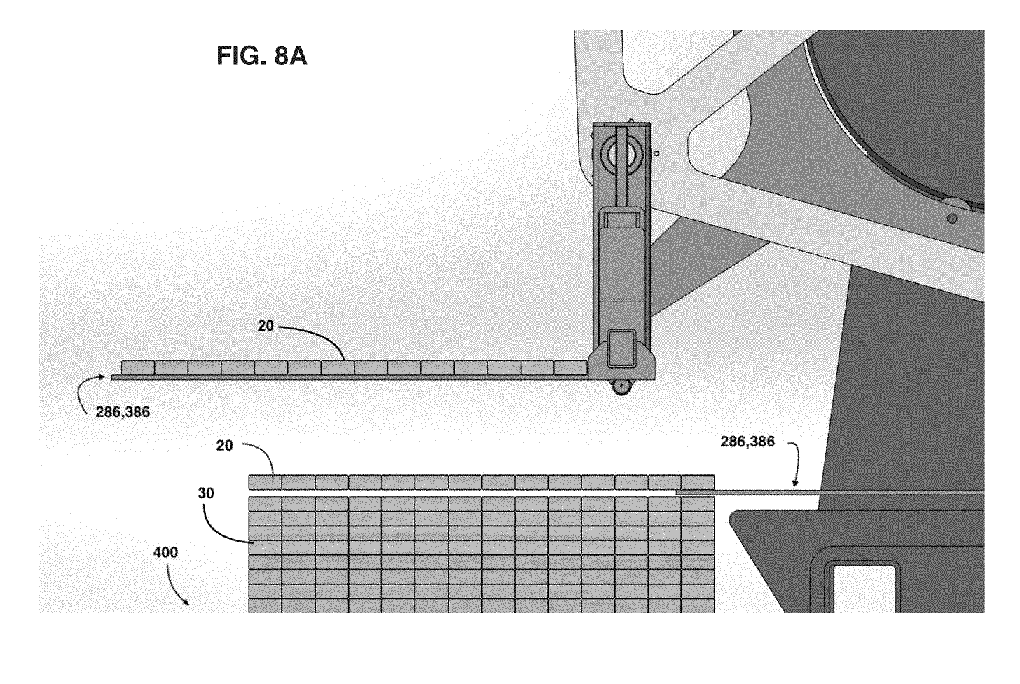

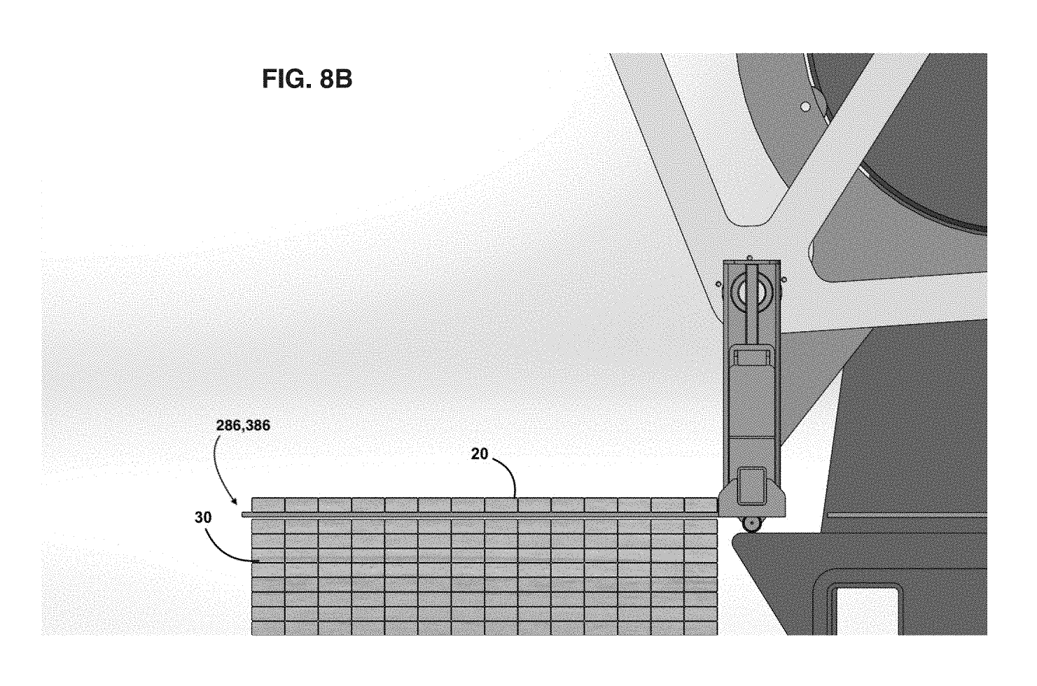

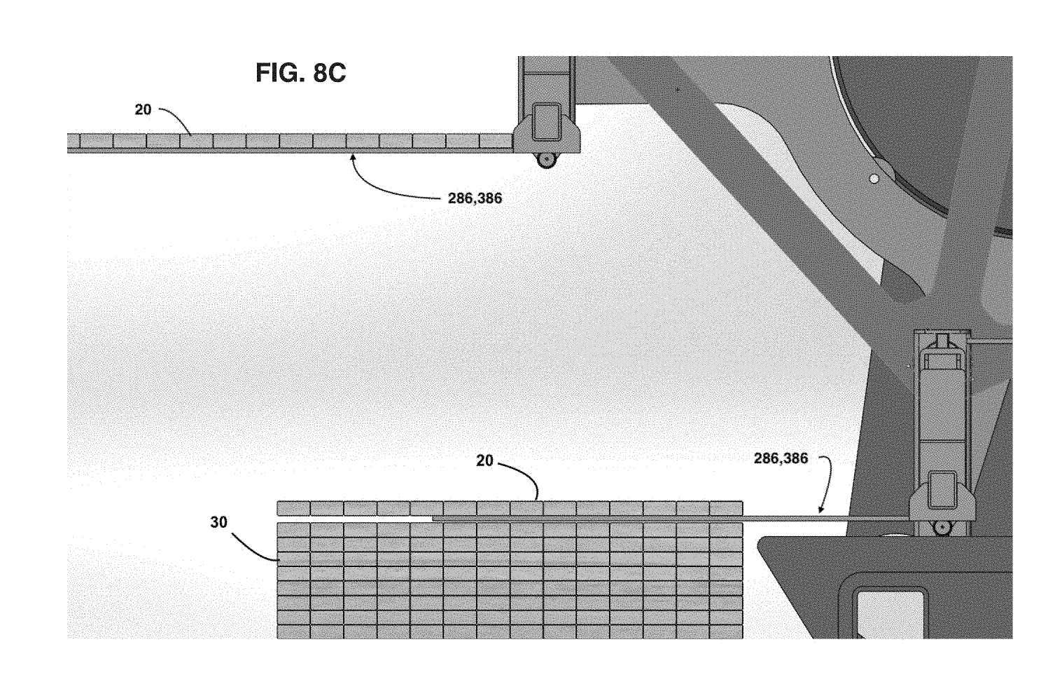

It must be noted that many solutions are available to place a layer 20 on the stacking blades 286, 386 of the stacking machine 10. As illustrated through FIGS. 7 and 8A-C, a feeding conveyor machine 600 may be installed upstream to feed the stacking machine 10 with layers 20 of elongated members 22. Typically, the feeding conveyor machine 600 is mounted to have the conveyor 610, e.g. conveyor belt or conveyor chain(s), extending transversally in the area between the stackers 200, 300 located on both sides of the conveyor 610. The conveyor 610 is thus located in the free area between the stacking blades 286, 386. The conveyor 610 thus is able to feed the stacking machine 10 with a layer 20 without interference with the stacking blades 286, 386. Once fed, the master wheels 250, 350 rotate to lift the layer 20 (i.e., to pick up a layer 20) and to place the next set of stacking blades 286, 386 in the loading position. At this time, the conveyor 610 drives a new layer in the loading position for the next set of stacking blades 286, 386 to pick up the layer. As the stacker machine 10 operates, layers are picked up and piled up on the stack 30. That process is a continuous process wherein stacking blades 286, 386 are either loading, moving a layer 20 toward the stack 30, placing the layer 20 on top of the stack 30, moving substantially horizontally afterwards to remove in a slide motion the stacking blades 286, 386 from under the layer 20, or moving back to the stacking position.

Typically, the assembly of a layer 20 is performed on the feeding conveyor machine 600, the layer 20 arriving complete to the stacking machine 10. One must understand that many solutions exists to assemble pieces of lumber 22 into layers 20 and to feed the layers 20 to the stacking machine 10. The above-described feeding conveyor machine 600 is only one and has been selected for teaching purposes only.

FIGS. 8A to 8C illustrates the sequence, with FIG. 8A illustrating a first layer 20 being laid on top of the stack 30 and another layer 20 approaching the stack 30. FIG. 8B illustrates the previously approaching layer 20 laid over the stack 30, the stacking blades still under the layer 20. FIG. 8C illustrates the new layer 20 remaining on top of the stack 30, forced to remain in place on the stack 30 as abutting a stack guide (not shown) abutting the upstream side of the layer 20 and preventing the layer 20 from moving upstream with the supporting stacking blades 286, 386.

It must be noted that, as illustrated, the stacking blades 286, 386 remain substantially horizontal over a full rotation of the master wheels 250, 350, or, in other words, the full cycle. The stacking blades 286, 386 remains in the same orientation (horizontal) regardless the angle of the master wheels 250, 350.

It must be noted that the stacking blades 286, 386 lay the layers 20 at a constant height. Therefore, the stacking table 400 steps down of a distance equal to the height of a layer 20 after the new layer 20 is placed over the stack 30 The top surface of the stack 30 thereby remains at a constant height. The height of the stacking table 400 is operated, as explained before, by a motor and its associated detectors.

It is noteworthy to say that the above embodiment has been selected for teaching purpose. Alternative embodiments are possible, for instance having the slave wheel disposed inwardly relative to the stackers. Accordingly, the master wheel would be mounted on a drum and would be driven by a combination of gears for instance. In the present alternative, the link arms would have a first vertical section joining the wheels and a second vertical section inward to the slave wheel for a sliding sleeve to be mounted to.

According to alternative embodiments, any one of the higher wheel and the lower wheel may be selected to be the master wheel or the slave wheel. The structure of the wheels, the determination of which of the wheels is mounted to a drum may also vary. Which of the wheels is mounted to a shaft or axle, the shaft or axle being mounted to the drum or passing through the drum to be mounted to the body of the stacker are also available alternatives that are intended to be within the scope of the present description.

Further design alternatives comprise the number of stacking arms. The number of stacking arms have been described as five (5). One must understand that the number of stacking arms is a decision of design. The characteristics of the pieces of lumber, the characteristics of the layer, the distance between the axes of rotation of the wheels, the distance between the link rotation axes and the wheel rotation axes, etc., are all parameters to be taken into account for the determination of the number of stacking arms.

Further design alternatives comprise the use of a single stronger stacker with a longer stacking arm mounted thereto. Accordingly, at least two stacking blades are slidably mounted thereto. Another alternative comprises a motor, such as an orbital motor mounted directly to the driving shaft driving the stacker. Another alternative resides in the stacking table being either mounted to a common structure as the frame, or independently from a frame or one or more stackers.

Further design alternative encompasses the selection of the driving components, for example the number of motors, the nature of the power feeding the motor(s), the selection of the power transmission components such as gears, belts and chains, the location of the driving components, etc.

While embodiments have been described above and illustrated in the accompanying drawings, it will be evident to those skilled in the art that modifications may be made without departing from this disclosure. Such modifications are considered as possible variants comprised in the scope of the disclosure.

1. A stacking machine for stacking elongated members, the stacking machine comprising:
a stacker comprising:
a master wheel;
a slave wheel mounted eccentrically relative to the master wheel;
a link arm assembly linking the master wheel and the slave wheel; and
a stacking arm assembly mounted to the link arm assembly;
wherein, under rotation of the master wheel, the slave wheel is driven to rotate hence driving the stacking arm assembly to rotate to receive layers of elongated members and to move them to form a stack using the layers of elongated members.

2. The stacking machine of claim 1, wherein the link arm assembly comprises a linking arm pivotably mounted to the master wheel and to the slave wheel, thereby joining the master wheel and the slave wheel.

3. The stacking machine of claim 1, wherein the stacking arm assembly comprises a stacking arm rigidly mounted to the link arm assembly, wherein orientation of the linking arm determines orientation of the stacking arm.

4. The stacking machine of claim 3, wherein the orientation of the stacking arm remains constant over a rotation of the master wheel.

5. The stacking machine of claim 3, wherein the stacking arm assembly comprises:
an extend segment extending from the stacking arm; and
a stacking blade mounted substantially perpendicular to the extend segment,
wherein the stacking blade receives the layers of elongated members.

6. The stacking machine of claim 5, wherein the stacking arm assembly comprises a slidable sleeve mounted to the stacking arm and to which is mounted the extend segment.

7. The stacking machine of claim 1, wherein the stacking machine comprises at least two link arm assemblies and a corresponding number of stacking arm assemblies.

8. The stacking machine of any one of claims 1, further comprising a driving shaft driving the master wheel, and a drum on which is mounted to the slave wheel, wherein the shaft passes through the drum.

9. The stacking machine of any one of claims 1, further comprising another stacker, wherein the corresponding ones of the stacking arm assemblies of the stacker and the other stacker define a stacking plane to receive a layer of elongated members.

10. The stacking machine of claim 9, wherein the stacker and the other stacker are mounted at a distance from each other providing clearance therebetween for a conveyor to feed the stacking machine with layers of elongated members.

11. The stacking machine of claim 9, further comprising a frame, a motor and a main driving shaft mounted to the frame and driven by the motor, wherein the motor drives the stacker and the other stacker through the main driving shaft.

12. The stacking machine of any one of claims 9, further comprising a frame and skates, wherein one of the stacker and the other stacker is mounted to the skates themselves mounted to the frame, and wherein one of the stacker and the other stacker is slidable toward and away from the cooperating stacker.

13. The stacking machine of any one of claims 1, further comprising a stacking table comprising supports supporting the stack of elongated members at a height relative to the frame, wherein the supports are motorized to adjust the height of the top of the stack.

14. The stacking machine of claim 13, further comprising a controller and a height detector, wherein the controller commands the motorized supports based on the height detected by the height detector.

15. The stacking machine of any one of claims 1, wherein the master wheel comprises a rotation axis, a plurality of link arm assemblies and axes about which the link arms assemblies are mounted to the master wheel, wherein the axes are at an equal distance from the rotation axis, and wherein the axes are equidistant from each other.

16. A stacking machine for stacking elongated members in a stack, the stacking machine comprising:
a pair of cooperating stackers mounted distant from each other, each of the stackers comprising:
a master wheel;
a slave wheel mounted eccentrically relative to the master wheel;
a link arm assembly linking the master wheel and the slave wheel; and
a stacking arm assembly mounted to the link arm assembly;
wherein, under rotation of the master wheels, the slave wheels are driven to rotate hence driving a pair of corresponding stacking arm assemblies from the stackers to rotate to receive layers of elongated members and to move them to form a stack using the layers of elongated members.

17. The stacking machine of claim 16, wherein the stacking arm assemblies are mounted as a pair comprising a first stacking arm assembly from a first one of the pair of stackers and a second stacking arm assembly from a second one of the pair of stackers, wherein the pair of stacking arm assemblies define a stacking plane to receive a layer of elongated members.

18. The stacking machine of any ones of claims 16, wherein the stacker and the other stacker are mounted at a distance from each other providing clearance therebetween for a conveyor to feed the stacking machine with layers of elongated members.

19. The stacking machine of any one of claims 16, further comprising a frame, a motor and a main driving shaft mounted to the frame and driven by the motor, wherein the motor drives the pair of stackers through the main driving shaft.

20. A stacker for a stacking machine adapted for stacking elongated members in a stack, the stacker comprising:
a base;
a master wheel mounted to the base;
a slave wheel mounted to the base eccentrically to the master wheel;
a stacking arm assembly concurrently mounted to the master wheel and the slave wheel causing the master wheel to drive the slave wheel; and
a stacking arm assembly mounted to the stacking arm assembly;
wherein, under rotation of the master wheels, the slave wheels are driven to rotate hence driving a pair of corresponding stacking arm assemblies from the stackers to rotate to receive layers of elongated members and to move them to form a stack using the layers of elongated members.
